(19) United States
(12) Patent Application Publication
(10) Pub. No.: US 2023/0244606 A1
(43) Pub. Date: Aug. 3, 2023

(54) CIRCUITRY AND METHOD

(71) Applicant: Arm Limited, Cambridge (GB)

(72) Inventors: Geoffray LACOURBA, Nice (FR); Luca NASSI, Antibes (FR); Damien CATHRINE, Mougins (FR); Stefano GHIGGINI, Antibes (FR); Albin Pierrick TONNERRE, Nice (FR)

(21) Appl. No.: 17/592,022

(22) Filed: Feb. 3, 2022

(51) Int. Cl. G06F 12/0862

(52) U.S. Cl. CPC G06F 12/0862; G06F 2212/602

(57) ABSTRACT

Circuitry comprises a memory system to store data items; cache memory storage to store a copy of one or more data items, the cache memory storage comprising a hierarchy of two or more cache levels; detector circuitry to detect at least a property of data items for storage by the cache memory storage; and control circuitry to control eviction, from a given cache level, of a data item stored by the given cache level, the control circuitry being configured to select a destination to store a data item evicted from the given cache level in response to a detection by the detector circuitry.

### BACKGROUND

This disclosure relates to circuitry and methods.

Some data handling circuitries make use of cache storage to hold temporary copies of data items such as so-called cache lines. the cache storage may comprise a hierarchy of cache levels, for example varying in access speed, physical and/or electrical proximity to a data accessing device such as a processing element, and/or capacity.

A data item can be evicted from a given cache level in order to make room for a newly allocated data item.

### SUMMARY

In an example arrangement there is provided circuitry comprising:
a memory system to store data items;
cache memory storage to store a copy of one or more data items, the cache memory storage comprising a hierarchy of two or more cache levels;
detector circuitry to detect at least a property of data items for storage by the cache memory storage; and
control circuitry to control eviction, from a given cache level, of a data item stored by the given cache level, the control circuitry being configured to select a destination to store a data item evicted from the given cache level in response to a detection by the detector circuitry.

In another example arrangement there is provided a method comprising:
storing data items by a memory system;
storing a copy of one or more data items by cache memo storage, the cache memory storage comprising a hierarchy of two or more cache levels;
detecting at least a property of data items for storage by the cache memory storage;
controlling eviction, from a given cache level, of a data item stored by the given cache level; and
selecting a destination to store a data item evicted from the given cache level in response to a detection by the detecting step.

Further respective aspects and features of the present technology are defined by the appended claims.

### BRIEF DESCRIPTION OF THE DRAWINGS

The present technique will be described further, by way of example only, with reference to embodiments thereof as illustrated in the accompanying drawings, in which:

FIG. 1 schematically illustrates example circuitry;

FIG. 2 schematically illustrates a further example circuitry;

FIG. 3 schematically illustrates features of cache control and prefetch circuitry;

FIG. 4 schematically illustrates data routing with a cache hierarchy;

FIGS. 5 to 7 respectively illustrate example features of the circuitry of FIG. 3; and

FIG. 8 is a schematic flowchart illustrating a method.

### DESCRIPTION OF EMBODIMENTS

### Example Circuitry-Overview

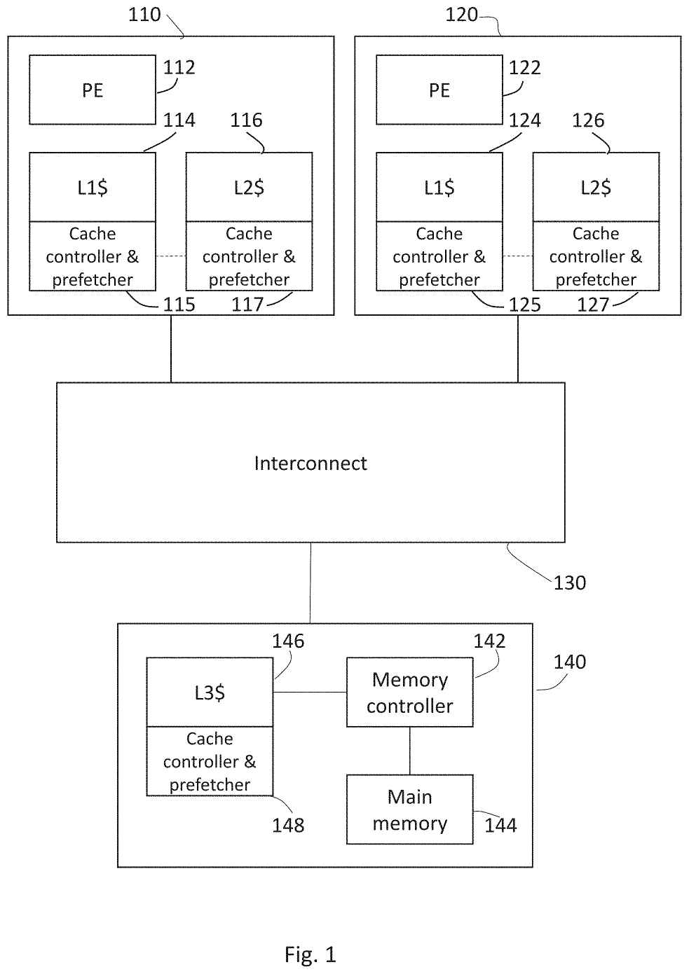

Referring now to the drawings, FIG. 1 schematically illustrates data processing circuitry 100 comprising one or more processors 110, 120 each having at least a processing element 112, 122 associated with cache storage comprising, in this example, a level I cache memory (L1$) 114, 124 having an associated cache controller and prefetcher 115, 125, and a private level II cache memory (L2$) 116, 126 also having an associated cache controller and prefetcher 117, 127.

The processors 110, 120 are connected to an interconnect 130 which provides at least a data connection with a memory system 140 configured to store data (comprising data items), so that data can be transferred between either of the processors 110, 120 and the memory system 140, in either direction.

The memory system 140 comprises at least a memory controller 142 to control access to a main memory 144 such as a DRAM memory. The memory controller is associated with a level III cache memory (L3$) 146 having an associated cache controller and prefetcher 148.

The instances of the L1$, L2$ and L3$ provide an example of cache memory storage to store a copy of one or more data items, the cache memory storage comprising a hierarchy of two or more cache levels. In particular, in the example shown, the hierarchy comprises three cache levels. The L1$ is physically/electrically closest to the respective processing element and is generally small and fast so as to provide very low latency storage and recovery of data items for immediate use by the respective processing element. Each further successive cache level (L2$, L3$ in that order) is generally physically/electrically further from the processing element than the next higher level and is generally arranged to provide slightly higher latency storage, albeit of potentially a larger amount of data, than the next higher level.

In each case, however, accessing a data item from any one of the cache levels is considered to be somewhat faster than accessing that data item from the memory system.

In the present example, the cache levels are exclusive, which is to say that storing a data item in one cache level does not automatically cause the data item to be available at another cache level; a separate storage operation is performed to achieve this, However, even if this were not the case, given that the different cache levels have different respective sizes or capacities, in a non-exclusive arrangement it would still be appropriate for some data items to be stored specifically in a given cache level. In other words, in some examples the cache levels are exclusive so that the cache memory storage requires separate respective storage operations to store a data item to each of the cache levels.

As discussed, each cache level is associated with respective prefetcher circuitry configured to selectively prefetch data items into that cache level. Prefetching involves loading a data item in advance of its anticipated use, for example in response to a prediction made by prediction circuitry (not shown) and/or a control signal received from one or more of the processors. Prefetching can apply to at least a subset of data items which may be required for use by the processors. It is not necessarily the case that any data item can be prefetched, but for the purposes of the present discussion it is taken that any data item which has previously been prefetched is “prefetchable”, which is to say capable of being prefetched again.

Prefetching can take place into any of the cache levels, and indeed a data item could be prefetched into more than one cache level. A respective cache controller attends to the placement of a data item in the cache memory storage under control of that cache controller and also to the eviction of a data item from the cache memory storage, for example to make space for a newly allocated data item.

The data items might be, for example, cache lines of, for example, 8 adjacent the addressed data words.

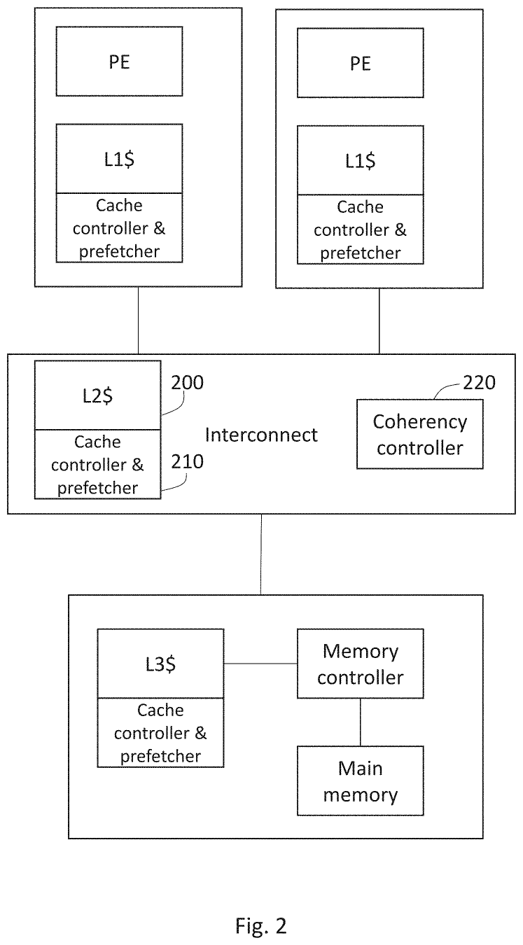

As further background, in another example shown in FIG. 2, the arrangement is similar to that of FIG. 1 except that a common or shared level II cache memory (L2$) 200 with an associated cache controller and prefetcher 210 may be provided so that it is accessible by two or more (for example, each) of the processors. For example, the shared L2$ may be provided at the interconnect circuitry. FIG. 2 also shows an example of a coherency controller 220, which again may be provided in a shared manner at the interconnect circuitry so as to control coherency as between the different instances of memory storage in the system. Here, controlling coherency implies that wherever a data item is stored within the overall system covered by the coherency controller 220, if a change is made to any stored instance of that data item, a subsequent read operation will retrieve the correct and latest version of that data item.

In further example arrangements, different caching strategies can be implemented. For example, the L2$ could be private to each processor (that is to say, each processor has its own L2$), while the interconnect may be provided with an L3$ along with a coherency controller.

Example arrangements to be discussed below concern techniques for use by the cache controllers to determine where to store a data item to be evicted from a given cache level. Generally speaking, an evicted data item would not then be stored at a higher cache level (for example, a data item evicted from the level II cache memory would not then be populated into the level I cache memory) but instead the evicted data item could be placed in a lower cache memory within the hierarchy or indeed deleted (if it is unchanged) or written back to the memory system (if it has been changed). Example criteria by which these determinations may be made will be discussed below.

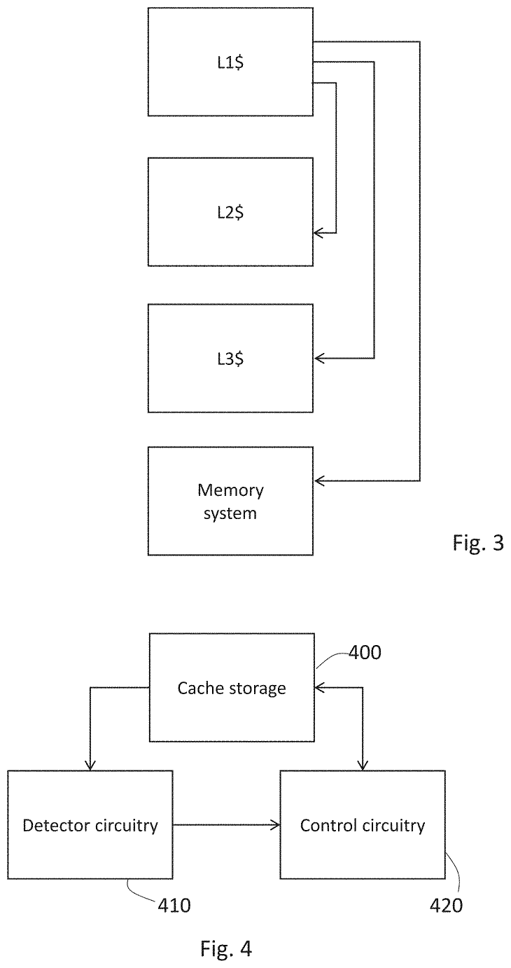

These possibilities are shown schematically by FIG. 3, in which a data item evicted from, for example, the L1$ can be routed to any one (or more) of the L2$, the L3$ and the memory system, for example according to control operations and criteria to be discussed below.

### CACHE CONTROL EXAMPLE

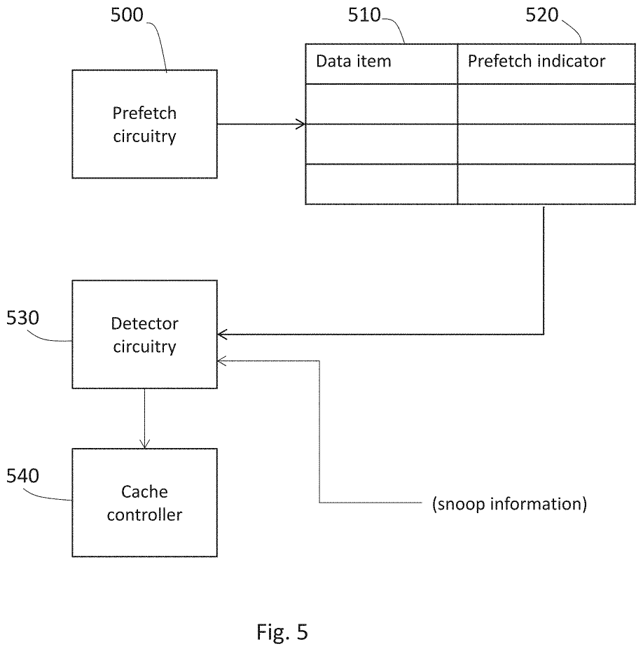

FIG. 4 schematically represents a simplified example of a least a part of the functionality of any one of the cache levels, in that the cache level has associated cache storage 400 and also, implemented as at least part of the functionality of the respective cache controller, detector circuitry 410 and control circuitry 420. In general terms, the detector circuitry 410 is arranged to detect at least a property of data items for storage by the cache memory storage. Similarly, in general terms, the control circuitry 420 is arranged to control eviction, from a given cache level, of a data item stored by the given cache level, the control circuitry being configured to select a destination to store a data item evicted from the given cache level in response to a detection by the detector circuitry.

In general terms, at least some of the examples given below aim to identify data items which are deemed likely not to be reused but yet are also prefetchable in the case of any required future access. For the such data items, the performance impact imposed by not allocating the data item in a next-lower cache level upon eviction from a given cache level is considered to be relatively low.

### Detection Example 1

In a first example, the prefetcher circuitry associated with a given cache level is arranged to prefetch data items to the cache memory storage as discussed above.

The cache memory storage is configured to associate a respective prefetch status indicator with data items stored by the cache memory storage, the prefetch status indicator indicating whether that data item was prefetched by the prefetch circuitry. This indication of “was prefetched” is used in the present context as a proxy for a determination of “can be prefetched if required again in the future”. This determination can be used by the detector circuitry which can be configured to detect a state of the prefetch status indicator associated with data item evicted from the given cache level. In general terms, a data item deemed to be “prefetchable” can be preferentially not allocated to a next-lower cache level upon eviction from the given cache level, whereas a data item deemed not to be “prefetchable” can be preferentially allocated to a next-lower cache level upon eviction from the given cache level.

The given cache level may be level I, for example.

Optionally, this first example may also use other criteria. For example:
was the data item initially loaded by a prefetcher associated with the given cache level?
is the data item not present at a next-lower level or was it prefetched from that next-lower level? (in other words, detector circuitry may be configured to detect whether the data item evicted from the given cache level is already stored by another cache level)
has the data item already been accessed by a demand access before being evicted? (in other words, the detector circuitry is configured to detect whether the data item evicted from the given cache level has been the subject of a data item access operation such as a load or store operation)

In an example arrangement, a subset of data items for eviction is identified for which the answer to the three supplementary detections listed above, along with the detection of “prefetchable” status, are all affirmative.

In the case of this subset of data items for eviction, for example from the level I cache storage, these data items may be preferentially not allocated to a next lower (or other lower) cache level. Data items not in the subset of data items for eviction may be preferentially allocated to a next lower (or other lower) cache level. In some examples, data items not in the subset of data items may routinely be stored in the next-lower cache level upon eviction from the given cache level.

Therefore, for example, the control circuitry may be configured to control storage of the data item evicted from the given cache level to another cache level lower in the hierarchy when the data item evicted from the given cache level has not yet been the subject of a data item access operation.

### Routing Example 2

In response to any one or more of the detections listed above, or in a specific example, in connection with the identified subset of data items for eviction, example embodiments can determine whether or not to store an evicted data item in a next lower cache level based upon further criteria to be discussed below.

So, the selection of candidate data items for which this determination is made may be based upon one or more properties of the data items (for example, prefetchable; has been subject of a data item access; and the like, as discussed above) and indeed, candidate data items for which this determination is made may (in some examples) be only those data items in the subset of data items identified in the discussion above.

The determination relates to whether an evicted data item (of those identified as candidates) should be allocated in a next lower cache level. For example, in connection with a data item evicted from L1$, should that data item be allocated to L2$ or instead to L3$ or even the memory system?

In example arrangements, this determination is based upon a detection, by the detector circuitry, of an operational parameter of another cache level lower in the hierarchy than the given cache level. In such cases, the control circuitry may be configured to selectively control storage of the data item evicted from the given cache level to one of the other cache levels lower in the hierarchy in response to the detected operational parameter.

For example, the operational parameter may be indicative of a degree of congestion of the other cache level lower in the hierarchy, the control circuitry being configured to inhibit storage of the data item evicted from the given cache level to the other cache level lower in the hierarchy when the operational parameter indicates a degree of congestion above a threshold degree of congestion.

For example, in the case of a data item to be evicted from L1$, and assuming the data item has been identified as a candidate data item as discussed above, a determination as to whether that data item should be allocated to L2$ can depend upon a detection of the an operational parameter, for example indicative of the current usage of the appropriate L2$ (whether a private L2$ or a shared L2$), according to criteria including one or more of the L2$ occupancy, pipeline activity and tracking structure occupancy. Any one or more of these criteria can be detected as a numerical indicator and compared with a threshold value (the polarity in the examples discussed here being such that a higher indicator is indicative of a greater current loading on the L2$, but of course the other polarity could be used).

In examples in which more than one criterion is detected, the comparison with the respective threshold value can be such that if any one or more detected indicators exceeds the threshold then the data item is not routed to the L2$. In other examples, the arrangement can be such that the data item is routed to the L2$ unless all of the detected indicators exceeds their respective threshold.

In these examples, it is considered potentially more beneficial to evict a data item identified as a candidate data item from the L1$ to the L3$ (and not to the L2$) in situations in which the L2$ circuitry is currently heavily loaded or congested. On the contrary, if the L2$ is currently lightly loaded or congested then it can be more advantageous to store the evicted data item in L2$, so as to provide potentially more rapid future access to that data item.

The detection and determination based upon the operational parameter can be based upon a smoothed sampling of the operational parameter. For example, the determination regarding the operational parameter for L2$ can be based upon a rolling set of samples, for example corresponding to 1024 successive evictions from L1$. Also, or instead, the threshold to go between modes of operation (one mode being that evicted candidate data items from L1$ are allocated to L2$; another mode being that evicted candidate data items from L1$ are not allocated to L2$) involves hysteresis so that the threshold changes in dependence upon the currently selected mode, so as to render it preferential to stay in the same mode rather than changing to the other mode.

Therefore, in some examples, the detector circuitry is configured to detect whether the data item evicted from the given cache level has been the subject of a load operation; and the control circuitry is configured to inhibit storage of the data item evicted from the given cache level to another cache level lower in the hierarchy when the data item evicted from the given cache level has been the subject of a data item access operation and when the respective prefetch status indicator indicating whether that data item was prefetched by the prefetch circuitry.

### Routing Example 3

This example may be employed in conjunction with or without the example referred to above as Routing example 2.

Here, with reference to candidate data items (for example the so-called subset of data items identified above) a determination can be made by the control circuitry as to whether an evicted data item should even remain in the cache structure. Here, not remaining in the cache structure refers to being deleted (when the data item is “clean”, which is to say unchanged with respect to a copy currently held by the memory system) or written back to the memory system (when the data item is “dirty”, which is to say different to the copy currently held by the memory system).

In example arrangements, candidate data items to be treated this way include those data items for which a data item access has been detected.

In some examples, an eviction does not in fact have to take place. Instead, in the case of data items which have not been modified (although used at least once by a data item access such as a load) the data item does not need to be evicted but the coherency controller can be informed of the loss of the data item. This arrangement can be used up to a threshold number of instances before being reset by the eviction of other clean lines which are not considered prefetchable.

In other words, in example arrangements the control circuitry may be configured to inhibit storage of the data item evicted from the given cache level to another cache level lower in the hierarchy when the data item evicted from the given cache level has been the subject of at least one load operation.

In the case of dirty data items, the control circuitry may be configured to control writing of the data item evicted from the given cache level to either or both of the memory system and another cache level in the case that the data item has undergone a write operation.

### Further Circuitry Examples

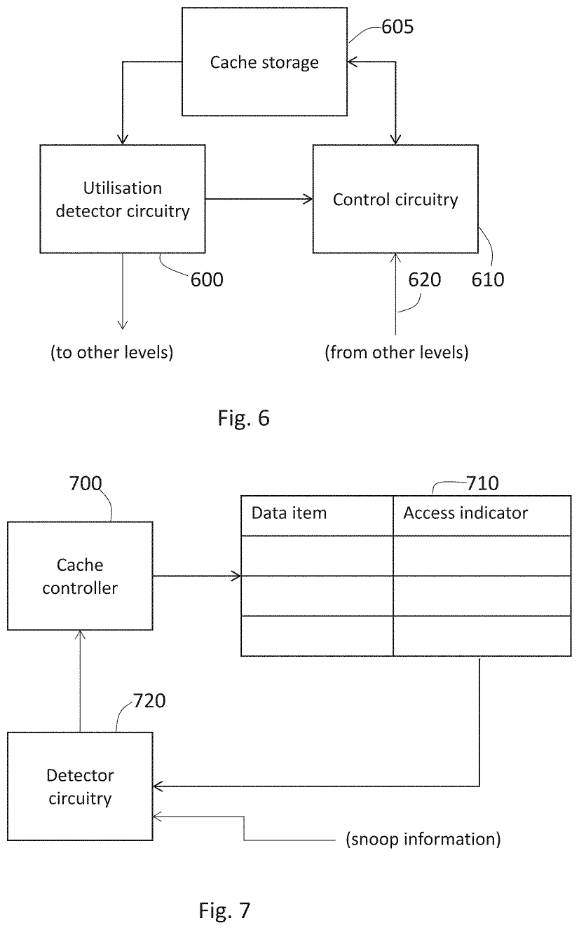

FIGS. 5-7 relates to circuitry features which may be used in connection with any of the techniques discussed above.

In FIG. 5, for a given cache level, a prefetcher 500 is responsible for prefetching a data item for storage by the given cache level as a data item 510 and four associating a prefetch indicator 520 with the respective data item. The prefetch indicator may be stored in a field associated with the data item storage itself, or in tag storage associated with the data item, or in separate prefetch indicator storage.

The detector circuitry 530 is responsive to the prefetch indicator to detect whether a data item is prefetchable as discussed above. The detector circuitry may also be responsive to so-called snoop information, for example provided by the coherency controller discussed above, indicative of the presence or absence of the data item in any other cache levels. The cache controller 540 acts according to any of the techniques discussed above in response to at least one or more of these pieces of information.

Referring to FIG. 6, the detector circuitry includes utilization detector circuitry 600 configured to interact with one or more other cache levels of the cache storage 605 to allow the detection of the operational parameter referred to above. Note that the utilization detector circuitry 600 may simply detect utilization or another operational parameter of the cache level at which it is provided and may pass this information to other cache levels, for example being received as information 620 by the control circuitry 610 of another cache level.

A further example arrangement is illustrated by FIG. 7 in which, for a given cache level, the cache controller 700 is configured to associate an access indicator 710 with each data item, the access indicator providing an indication of whether the data item has been subject to a data item access operation. The detector circuitry 720 is responsive at least to the access indicator and optionally to snoop information as discussed above, to make any of the detections discussed above.

In some examples, the circuitry techniques illustrated by FIGS. 5, 6 and 7 can be combined in any permutation; they are shown separately in the respective drawings simply for clarity of the description.

### Method Example

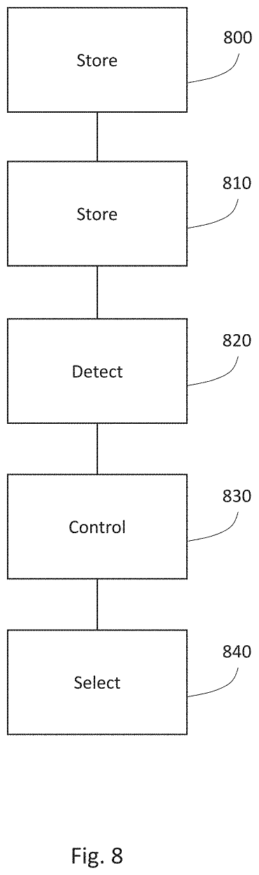

FIG. 8 is a schematic flowchart illustrating an example method comprising:
storing (at a step 800) data items by a memory system;
storing (at a step 810) a copy of one or more data items by cache memory storage, the cache memory storage comprising a hierarchy of two or more cache levels;
detecting (at a step 820) at least a property of data items for storage by the cache memory storage;
controlling (at a step 830) eviction, from a given cache level, of a data item stored by the given cache level; and
selecting (at a step 840) a destination to store a data item evicted from the given cache level in response to a detection by the detecting step.

### General Matters

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the present techniques have been described in detail herein with reference to the accompanying drawings, it is to be understood that the present techniques are not limited to those precise embodiments, and that various changes, additions and modifications can be effected therein by one skilled in the art without departing from the scope and spirit of the techniques as defined by the appended claims. For example, various combinations of the features of the dependent claims could be made with the features of the independent claims without departing from the scope of the present techniques.

Various respective aspects and features are defined by the following numbered clauses:

1. Circuitry comprising:
a memory system to store data items;
cache memory storage to store a copy of one or more data items, the cache memory storage comprising a hierarchy of two or more cache levels;
detector circuitry to detect at least a property of data items for storage by the cache memory storage; and
control circuitry to control eviction, from a given cache level, of a data item stored by the given cache level, the control circuitry being configured to select a destination to store a data item evicted from the given cache level in response to a detection by the detector circuitry.
   2. The circuitry of clause 1, comprising prefetch circuitry to prefetch data items to the cache memory storage; the cache memory storage being configured to associate a respective prefetch status indicator with data items stored by the cache memory storage, the prefetch status indicator indicating whether that data item was prefetched by the prefetch circuitry.
   3. The circuitry of clause 2, in which the detector circuitry is configured to detect a state of the prefetch status indicator associated with data item evicted from the given cache level.
   4. The circuitry of any one of clauses 1 to 3, in which the detector circuitry is configured to detect whether the data item evicted from the given cache level has been the subject of a data item access operation.
   5. The circuitry of clause 4, in which the control circuitry is configured to control storage of the data item evicted born the given cache level to another cache level lower in the hierarchy when the data item evicted from the given cache level has not yet been the subject of a data item access operation.
   6. The circuitry of any one of the preceding clauses, in which the detector circuitry is configured to detect an operational parameter of another cache level lower in the hierarchy than given cache level.
   7. The circuitry of clause 6, in which the control circuitry is configured to selectively control storage of the data item evicted from the given cache level to one of the other cache levels lower in the hierarchy in response to the detected operational parameter.
   8. The circuitry of clause 7, in which the operational parameter is indicative of a degree of congestion of the other cache level lower in the hierarchy, the control circuitry being configured to inhibit storage of the data item evicted from the given cache level to the other cache level lower in the hierarchy when the operational parameter indicates a degree of congestion above a threshold degree of congestion.
   9. The circuitry of any one of the preceding clauses, in which the detector circuitry is configured to detect whether the data item evicted from the given cache level is already stored by another cache level.
   10. The circuitry of any one of the preceding clauses as dependent upon clause 3, in which:
the detector circuitry is configured to detect whether the data item evicted from the given cache level has been the subject of a data item access operation;
the control circuitry is configured to inhibit storage of the data item evicted from the given cache level to another cache level lower in the hierarchy when the data item evicted from the given cache level has been the subject of a data item access operation and when the respective prefetch status indicator indicating whether that data item was prefetched by the prefetch circuitry.
   11. The circuitry of clause 10, in which:
the detector circuitry is configured to detect an operational parameter of another cache level lower in the hierarchy than the given cache level; and
the control circuitry is configured to selectively control or inhibit storage of the data item evicted from the given cache level to the other cache level lower in the hierarchy in response to the detected operational parameter.
   12. The circuitry of clause 11, in which the operational parameter is indicative of a degree of congestion of the other cache level lower in the hierarchy, the control circuitry being configured to inhibit storage of the data item evicted from the given cache level to the other cache level lower in the hierarchy when the operational parameter indicates a degree of congestion above a threshold degree of congestion.
   13. The circuitry of any one of the preceding clauses as dependent upon clause 4, in which the control circuitry is configured to inhibit storage of the data item evicted from the given cache level to another cache level lower in the hierarchy when the data item evicted from the given cache level has been the subject of at least one load operation.
   14. The circuitry of any one of the preceding clauses, in which the control circuitry is configured to control writing of the data item evicted from the given cache level to either or both of the memory system and another cache level in the case that the data item has undergone a write operation.
   15. The circuitry of any one of the preceding clauses, in which the cache levels are exclusive so that the cache memory storage requires separate respective storage operations to store a data item to each of the cache levels.
   16. A method comprising:
storing data items by a memory system;
storing a copy of one or more data items by cache memory storage, the cache memory storage comprising a hierarchy of two or more cache levels;
detecting at least a property of data items for storage by the cache memory storage;
controlling eviction, from a given cache level, of a data item stored by the given cache level; and
selecting a destination to store a data item evicted from the given cache level in response to a detection by the detecting step.

1. Circuitry comprising:
a memory system to store data items;
cache memory storage to store a copy of one or more data items, the cache memory storage comprising a hierarchy of two or more cache levels;
detector circuitry to detect at least a property of data items for storage by the cache memory storage; and
control circuitry to control eviction, from a given cache level, of a data item stored by the given cache level, the control circuitry being configured to select a destination to store a data item evicted from the given cache level in response to a detection by the detector circuitry.

2. The circuitry of claim 1, comprising prefetch circuitry to prefetch data items to the cache memory storage; the cache memory storage being configured to associate a respective prefetch status indicator with data items stored by the cache memory storage, the prefetch status indicator indicating whether that data item was prefetched by the prefetch circuitry.

3. The circuitry of claim 2, in which the detector circuitry is configured to detect a state of the prefetch status indicator associated with data item evicted from the given cache level.

4. The circuitry of claim 1, in which the detector circuitry is configured to detect whether the data item evicted from the given cache level has been the subject of a data item access operation.

5. The circuitry of claim 4, in which the control circuitry is configured to control storage of the data item evicted from the given cache level to another cache level lower in the hierarchy when the data item evicted from the given cache level has not yet been the subject of a data item access operation.

6. The circuitry of claim 1, in which the detector circuitry is configured to detect an operational parameter of another cache level lower in the hierarchy than the given cache level.

7. The circuitry of claim 6, in which the control circuitry is configured to selectively control storage of the data item evicted from the given cache level to one of the other cache levels lower in the hierarchy in response to the detected operational parameter.

8. The circuitry of claim 7, in which the operational parameter is indicative of a degree of congestion of the other cache level lower in the hierarchy, the control circuitry being configured to inhibit storage of the data item evicted from the given cache level to the other cache level lower in the hierarchy when the operational parameter indicates a degree of congestion above a threshold degree of congestion.

9. The circuitry of claim 1, in which the detector circuitry is configured to detect whether the data item evicted from the given cache level is already stored by another cache level.

10. The circuitry of claim 3, in which:
the detector circuitry is configured to detect whether the data item evicted from the given cache level has been the subject of a data item access operation;
the control circuitry is configured to inhibit storage of the data item evicted from the given cache level to another cache level lower in the hierarchy when the data item evicted from the given cache level has been the subject of a data item access operation and when the respective prefetch status indicator indicating whether that data item was prefetched by the prefetch circuitry.

11. The circuitry of claim 10, in which:
the detector circuitry is configured to detect an operational parameter of another cache level lower in the hierarchy than the given cache level; and
the control circuitry is configured to selectively control or inhibit storage of the data item evicted from the given cache level to the other cache level lower in the hierarchy in response to the detected operational parameter.

12. The circuitry of claim 11, in which the operational parameter is indicative of a degree of congestion of the other cache level lower in the hierarchy, the control circuitry being configured to inhibit storage of the data item evicted from the given cache level to the other cache level lower in the hierarchy when the operational parameter indicates a degree of congestion above a threshold degree of congestion.

13. The circuitry of claim 4, in which the control circuitry is configured to inhibit storage of the data item evicted from the given cache level to another cache level lower in the hierarchy when the data item evicted from the given cache level has been the subject of at least one load operation.

14. The circuitry of claim 1, in which the control circuitry is configured to control writing of the data item evicted from the given cache level to either or both of the memory system and another cache level in the case that the data item has undergone a write operation.

15. The circuitry of claim 1, in which the cache levels are exclusive so that the cache memory storage requires separate respective storage operations to store a data item to each of the cache levels.

16. A method comprising:
storing data terns by a memory system;
storing a copy of one or more data items by cache memory storage, the cache memory storage comprising a hierarchy of two or more cache levels;
detecting at least a property of data items for storage by the cache memory storage;
controlling eviction, from a given cache level, of a data item stored by the given cache level; and
selecting a destination to store a data item evicted from the given cache level in response to a detection by the detecting step.
